(19) United States
(12) Patent Application Publication
(10) Pub. No.: US 2026/0095574 A1
(43) Pub. Date: Apr. 2, 2026

(54) CODING ADAPTATIONS FOR PIECE-WISE SMOOTH VIDEO CONTENT SUPPORTING BOTH GUIDED AND UNGUIDED BLOCK-WISE CODING

(71) Applicant: Nokia Technologies Oy, Espoo (FI)

(72) Inventor: Sebastian SCHWARZ, Munich (DE)

(21) Appl. No.: 18/889,677

(22) Filed: Sep. 19, 2024

Related U.S. Application Data
(60) Provisional application No. 63/584,663, filed on Sep. 22, 2023.

(51) Int. Cl. H04N 19/14; H04N 19/176; H04N 19/70

(52) U.S. Cl. CPC H04N 19/14; H04N 19/176; H04N 19/70

(57) ABSTRACT

An encoder, implemented by an apparatus as part of an encoding process of input video, receives a picture and identifies the picture has blocks containing smooth content. The encoder encodes a bitstream including at least one coded picture. The encoder performs one or more adaptations to encoding decisions made in the encoding based on the identified blocks containing the smooth content. A decoder, implemented by an apparatus as part of a decoding process, receives a bitstream comprising video data and containing smooth content information from which a determination of which blocks contain smooth content can be made. The decoder decodes the video data, according at least to available coding adaptation information and the smooth content information.

### TECHNICAL FIELD

Examples of embodiments herein relate generally to video coding and decoding and, more specifically, relate to piece-wise smooth video content.

### BACKGROUND

Video coding is important for many reasons. One critical reason is compression, in that the required bandwidth of video is significantly reduced by an encoder when transmitted as a bitstream from the encoder. Typically, a number of transformations of the video are performed during the encoding process taken by the encoder, and often these involve block-wise coding techniques. In other words, blocks of video data are transformed or otherwise operated on during the encoding process.

While reducing size, however, efforts are made by the encoder so that when the bitstream is decoded, the decoded video has limited reconstruction distortion. One location when this is important is for encoding piece-wise smooth content. Consider a black-colored ball against a blue sky. The ball could be considered to be in a region of interest (ROI), a so-called foreground region, while the sky is a background region. While both the black ball and the blue sky are smooth in terms of their color content, at the edges of the ball, there is a dramatic change between the black color of the ball and the blue color of the sky. This transition between colors from foreground to background can cause challenges, such as introducing artifacts like blocking, ringing, and blurring when the compressed video is decoded.

These challenges are typically addressed, at least in the encoding process, so that there is a limited effect by the artifacts on the decoded video. This means that implementations taken into account the effects that might be caused in decoded video for a human that is viewing the decoded video, e.g., relative to the input video.

### BRIEF SUMMARY

This section is intended to include examples and is not intended to be limiting.

In an exemplary embodiment, a method is disclosed that includes receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

An exemplary computer program product includes a computer-readable storage medium bearing instructions that, when executed by an apparatus, cause the apparatus to perform at least the following: receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

In another exemplary embodiment, an apparatus comprises means for performing: receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

In an exemplary embodiment, a method is disclosed that includes receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

An exemplary computer program product includes a computer-readable storage medium bearing instructions that, when executed by an apparatus, cause the apparatus to perform at least the following: receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

In another exemplary embodiment, an apparatus comprises means for performing: receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

### BRIEF DESCRIPTION OF THE DRAWINGS

In the attached drawings:

FIG. 1 illustrates examples of piece-wise smooth video content;

FIG. 2 illustrates an example of a VVC in-loop filter;

FIGS. 3A and 3B are block diagrams illustrating volumetric media conversion at (FIG. 3A) an encoder and reconstruction at (FIG. 3B) a decoder, where the 3D media is converted to a series of 2D representations: occupancy, geometry, and attributes, and where additional atlas information is also included in the bitstream to enable inverse reconstruction;

FIG. 4, split into FIGS. 4A, 4B, and 4C, illustrates example V3C videos for texture attribute (FIG. 4A), geometry (FIG. 4B) and occupancy (FIG. 4C);

FIG. 5, split over FIGS. 5A, 5B, 5C, and 5D, illustrates parts of a V3C V-PCC decoding process for atlas (FIG. 5A), occupancy (FIG. 5B), geometry (FIG. 5C), and texture (FIG. 5D);

FIG. 6 is a general illustration of the pipeline of video coding for machines;

FIG. 7 is a block diagram of an ROI-enabled video codec for machines where the foreground regions are detected using an ROI detection network;

FIG. 8 shows sample values for an auxiliary picture;

FIG. 9 has two parts, FIGS. 9A and 9B, illustrating examples of overlapped mask case in JVET-AD0175, where an object mask auxiliary picture 0 (zero) is shown in FIG. 9A and an object mask auxiliary picture 1 (one) is shown in FIG. 9B;

FIG. 10 is a flow diagram of coding adaptations for piece-wise smooth video content;

FIG. 10A is a flow diagram describing additional examples of the preprocessing for category (1) from FIG. 10;

FIG. 10B is a flow diagram describing additional examples of the encoder operations for category (2) from FIG. 10;

FIG. 10C is a flow diagram describing additional examples of the encoder decisions for category (3) from FIG. 10;

FIG. 10D is a flow diagram describing additional examples of the signaling for category (4) from FIG. 10;

FIG. 11 illustrates an input image and an output image after applying a 2D-Sobel operator to the block of input image;

FIG. 12 is a flow diagram of part of a decoding process; and

FIG. 13 is an example of a block diagram of an apparatus suitable for implementing any of the encoders or decoders described herein.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

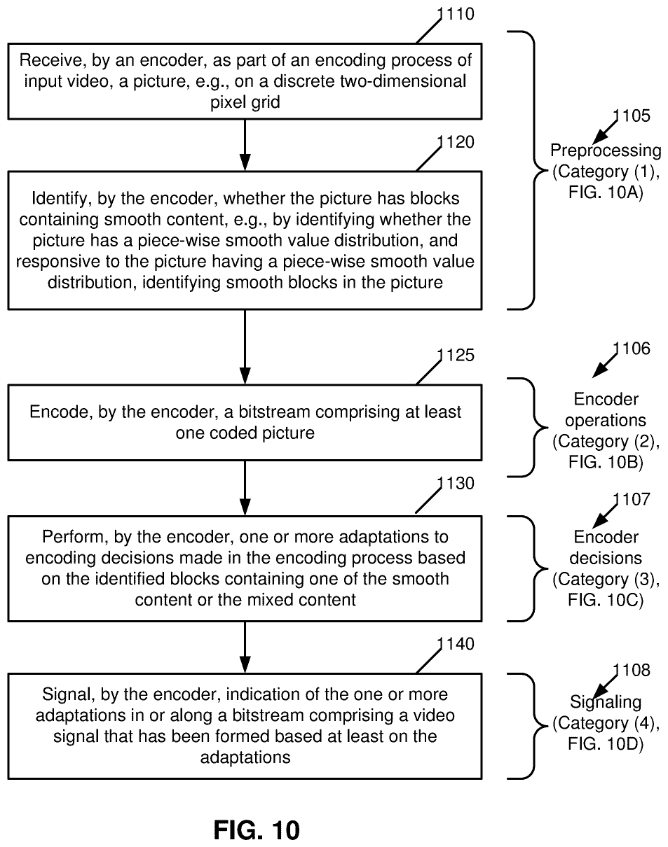

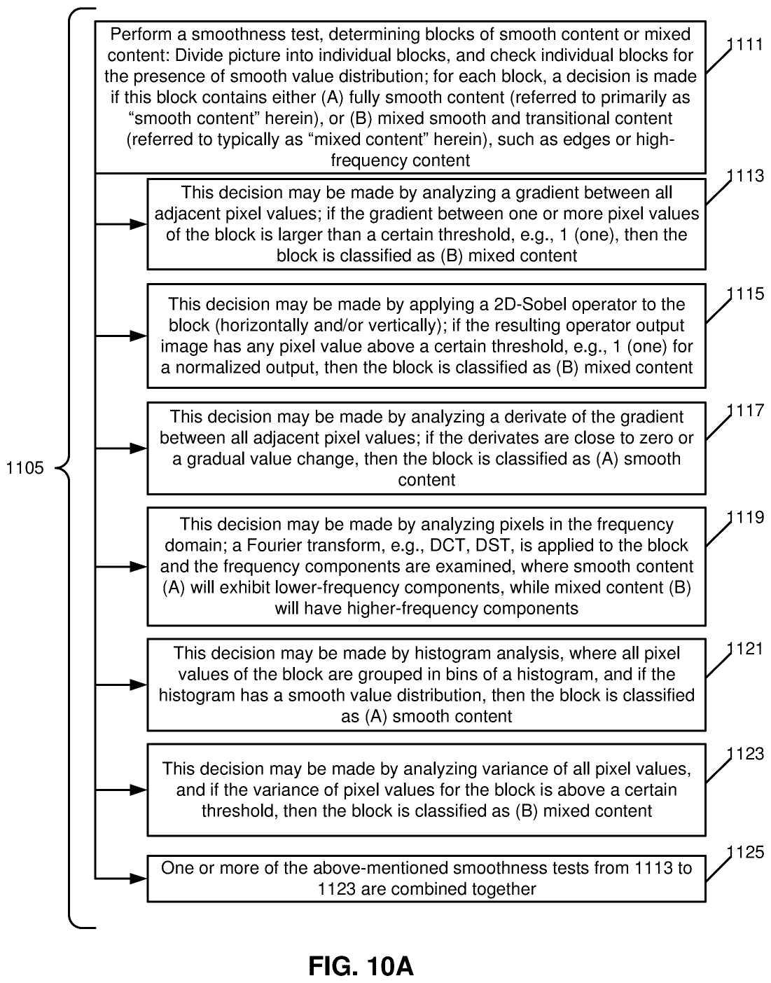

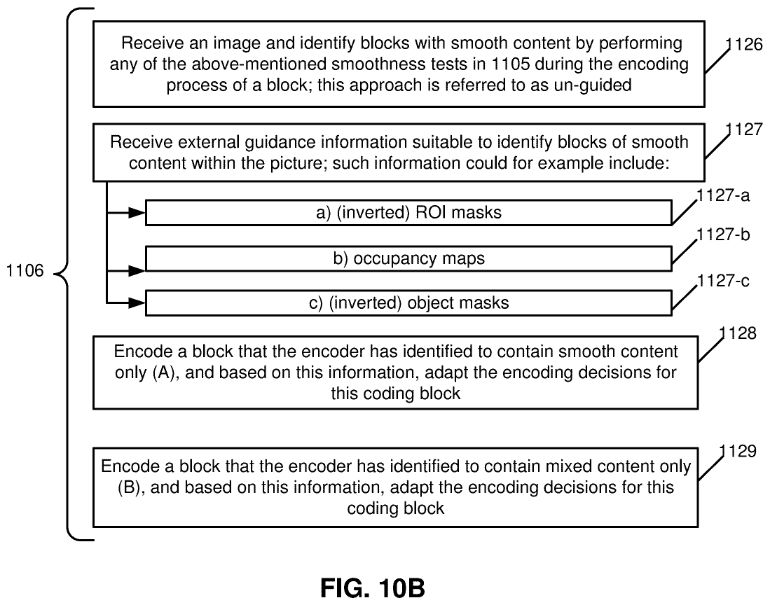

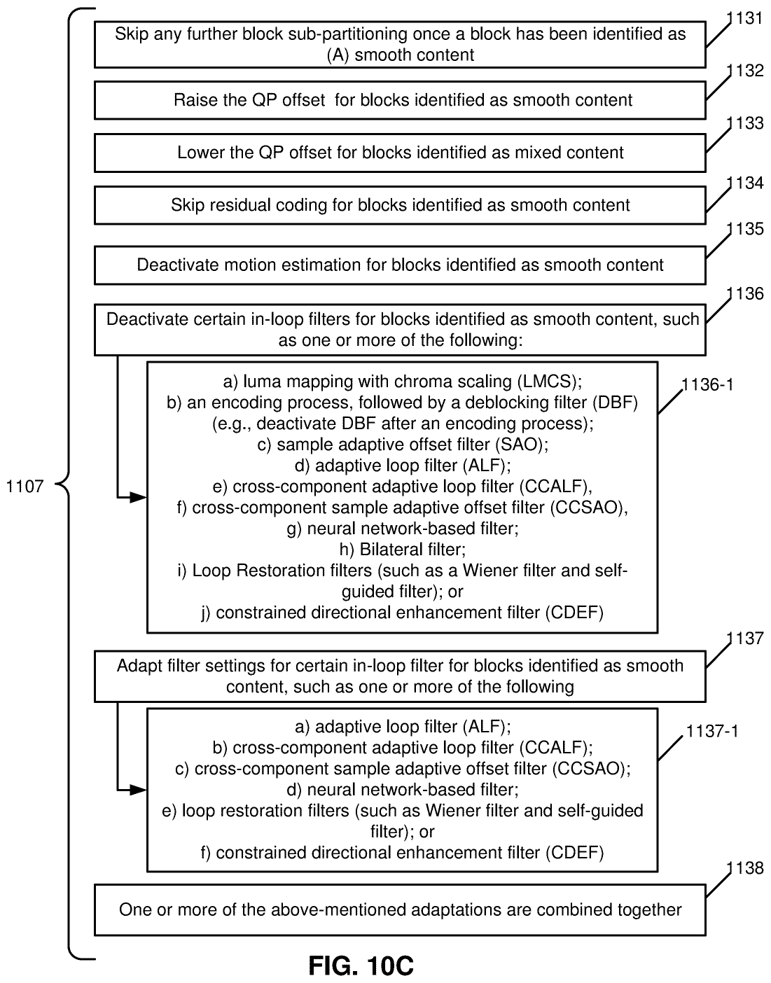

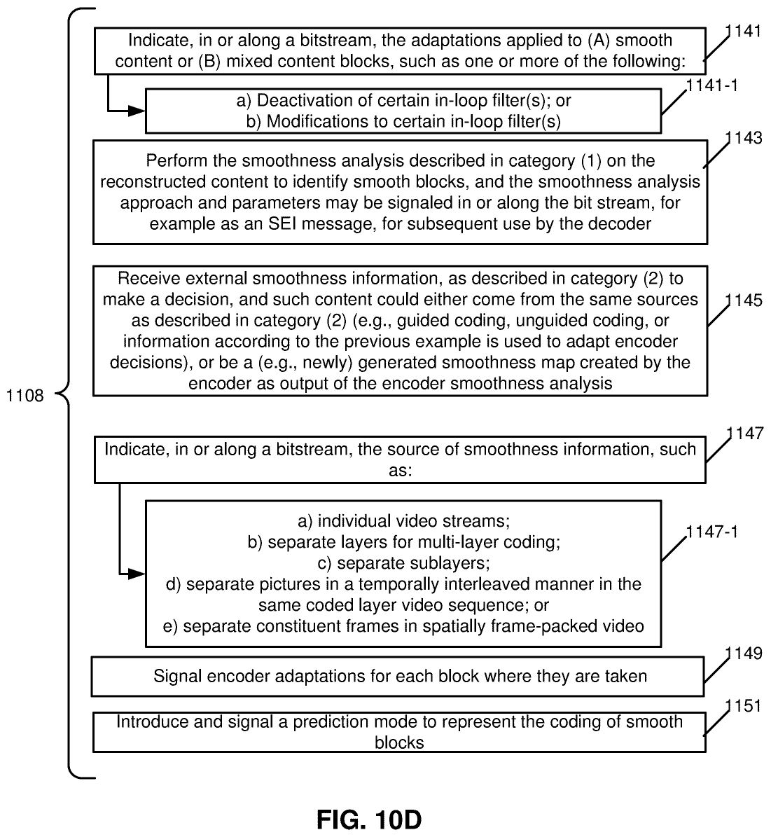

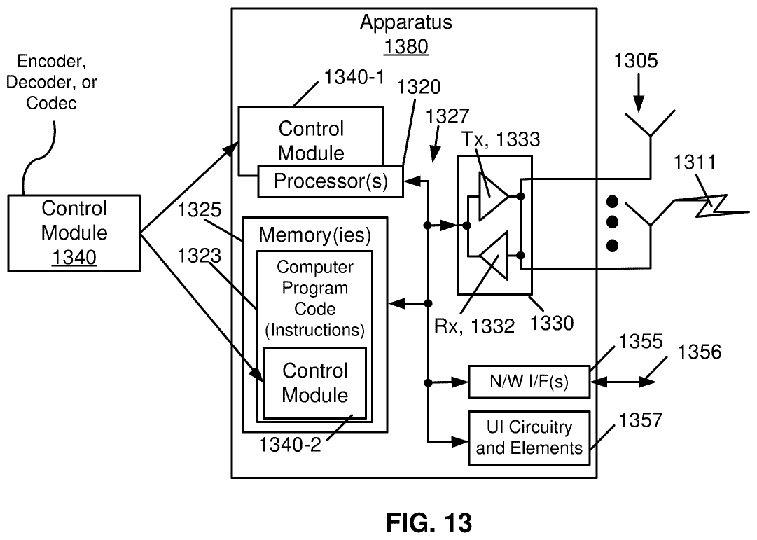

Any flow diagram (see FIGS. 10, 10A, 10B, 10C, and 10D, and 12) or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIG. 13) also illustrate the operation of an exemplary method, results of execution of computer program instructions embodied on a computer readable memory, functions performed by logic implemented in hardware, and/or interconnected means for performing functions in accordance with an exemplary embodiment.

Examples herein relate to piece-wise smooth video content. An introduction to this content is now provided.

A piece-wise smooth distribution refers to a value distribution that exhibits smoothness within certain intervals, while potentially having discontinuities or abrupt changes at specific points or boundaries. The smoothness property implies that the value distribution is continuous and has well-defined derivatives within each interval, ensuring a certain degree of regularity. However, at the points where the distribution transitions from one interval to another, there may be jumps or discontinuities in the value or its derivatives.

In the context of a two-dimensional signal, such as an image or video frame, a piece-wise smooth distribution refers to a distribution of pixel values that exhibits smoothness within certain regions or patches of the image while potentially having abrupt changes at the boundaries between these regions. Each region or patch can be considered a piece of the overall image, and within each piece, the pixel values vary smoothly, suggesting a certain degree of coherence or similarity.

The concept of piece-wise smoothness is particularly useful for describing images that consist of distinct objects or regions with varying textures, colors, or intensities. In such cases, the pixel values within each object or region tend to be relatively consistent and exhibit smooth variations, while the transitions between different objects or regions may lead to sudden changes in pixel values, resulting in edges or boundaries.

This type of distribution is commonly encountered in various types of video content, such as:
1) Depth images for 3D-video content;
2) Disparity images for stereoscopic content;
3) Geometry images in V3C video content (applies to V-PCC and MIV);
4) Displacement coding in V3C dynamic mesh coding (V-DMC);
4) Region of Interest (ROI) video content;
5) ROI masks for VCM;
6) Alpha mask video content; and/or
7) Object mask video content.

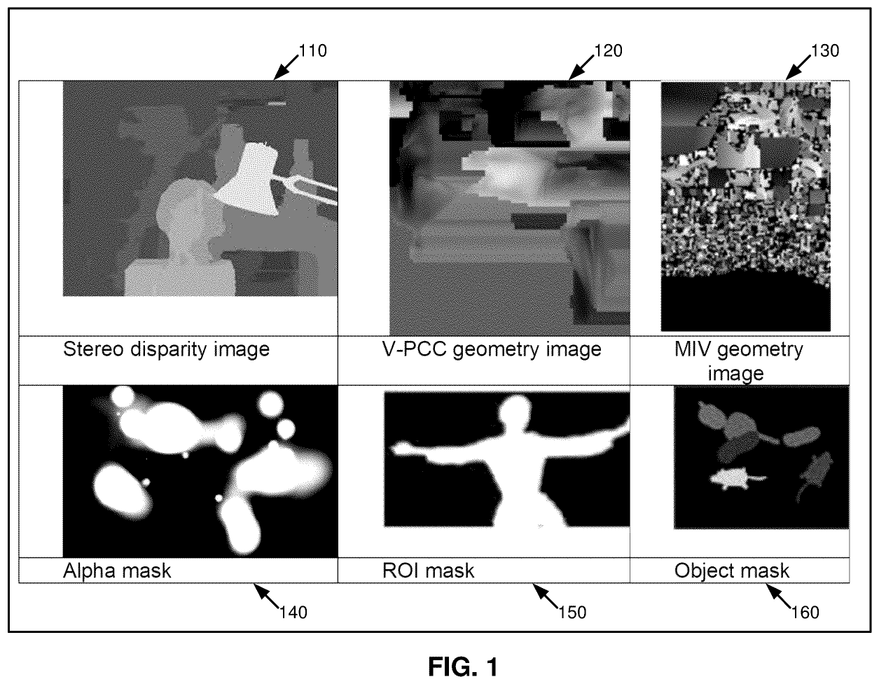

Examples of piece-wise smooth video content are shown in FIG. 1. This figure shows a stereo disparity image 110, a V-PCC geometry image 120, an MIV geometry image 130, an alpha mask 140, an ROI mask 150, and an object mask 160. Each of these shows how there are piece-wise smooth video content for some of the image, but then sudden changes in pixel values at edges or boundaries. Consider the lamp in the stereo disparity image 110, which has similar or the same pixel values within the confines of the lamp, but there is a sudden change in pixel values at the edges of the lamp.

Background on video coding is presented now. Hybrid video codecs, for example ITU-T H.263, H.264/AVC, HEVC, and VVC, may encode the video information in two phases. At first, pixel values in a certain picture are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. In the examples below, while the term “area” may be used, this commonly a block. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction, MCP) involve finding and indicating an area in one of the previously encoded video frames that corresponds closely to the block being coded. Inter prediction may reduce temporal redundancy.

Intra prediction, where pixel or sample values can be predicted by spatial mechanisms, involve finding and indicating a spatial region relationship. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In the syntax prediction, which may also be referred to as parameter prediction, syntax elements and/or syntax element values and/or variables derived from syntax elements are predicted from syntax elements (de)coded earlier and/or variables derived earlier. Non-limiting examples of syntax prediction are provided below.

In motion vector prediction, motion vectors, e.g., for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g., from CTU to CUs and down to PUs, may be predicted. In filter parameter prediction, the filtering parameters, e.g., for sample adaptive offset, may be predicted. Prediction approaches using image information from a previously-coded image can also be referred to as inter prediction methods, which may also be referred to as temporal prediction and motion compensation. Prediction approaches using image information within the same image can also be referred to as intra prediction methods.

Secondly, the prediction error, i.e., the difference between the predicted block of pixels and the original block of pixels, is coded. This may be performed by transforming the difference in pixel values using a specified transform (e.g., Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size of transmission bitrate).

In many video codecs, including H.264/AVC, HEVC, and VVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). In H.264/AVC, HEVC, and VVC, as many other video compression standards, a picture is divided into a mesh of rectangles, for each of which a similar block in one of the reference pictures is indicated for inter-prediction. The location of the prediction block is coded as a motion vector that indicates the position of the prediction block relative to the block being coded.

In Versatile Video Codec (VVC), there are the following new coding tools.

### 1) Intra-Picture Prediction:

a) 67 intra mode with wide angles mode extension;
b) Block size and mode dependent 4 tap interpolation filter;
c) Position dependent intra prediction combination (PDPC);
d) Cross component linear model intra prediction (CCLM);
c) Multi-reference line intra prediction;
f) Intra sub-partitions;
g) Weighted intra prediction with matrix multiplication.

### 2) Inter-Picture Prediction:

a) Block motion copy with spatial, temporal, history-based, and pairwise average merging candidates;
b) Affine motion inter prediction;
c) Sub-block based temporal motion vector prediction;
d) Adaptive motion vector resolution;
e) 8×8 block-based motion compression for temporal motion prediction;
f) High precision ( 1/16 pel) motion vector storage and motion compensation with 8-tap interpolation filter for luma component and 4-tap interpolation filter for chroma component;
g) Triangular partitions;
h) Combined intra and inter prediction;
i) Merge with MVD (MMVD);
j) Symmetrical MVD coding;
k) Bi-directional optical flow;
1) Decoder side motion vector refinement; and/or
m) Bi-prediction with CU-level weight.

### 3) Transform, Quantization and Coefficients Coding:

a) Multiple primary transform selection with DCT2, DST7 and DCT8;
b) Secondary transform for low frequency zone;
c) Sub-block transform for inter predicted residual;
d) Dependent quantization with max QP increased from 51 to 63;
e) Transform coefficient coding with sign data hiding; and/or
f) Transform skip residual coding.

### 4) Entropy Coding:

a) Arithmetic coding engine with adaptive double windows probability update.

### 5) In Loop Filter:

a) In-loop reshaping;
b) Deblocking filter with strong longer filter;
c) Sample adaptive offset; and/or
d) Adaptive Loop Filter.

### 6) Screen Content Coding:

a) Current picture referencing with reference region restriction.

### 7) 360-Degree Video Coding:

a) Horizontal wrap-around motion compensation.

### 8) High-Level Syntax and Parallel Processing:

a) Reference picture management with direct reference picture list signaling; and/or
b) Tile groups with rectangular shape tile groups.

Another topic of relevance is partitioning in VVC. In VVC, each picture is divided into coding tree units (CTUs) similar to HEVC. A picture may also be divided into slices, tiles, bricks and sub-pictures. CTUs may be split into smaller CUs using a quaternary tree structure. Each CU may be divided using quad-tree and nested multi-type tree including ternary and binary split. There are specific rules to infer partitioning in picture boundaries. The redundant split patterns are disallowed in nested multi-type partitioning.

As described above, a loop filter may be used in VVC. The purpose of in-loop filtering is to reduce artifacts and distortions that can occur during the compression process. Compression techniques such as block-based motion compensation and discrete cosine transform (DCT) can introduce artifacts such as blocking, ringing, and blurring in the decoded video. In-loop filtering is designed to reduce these artifacts and improve the perceived visual quality of the video.

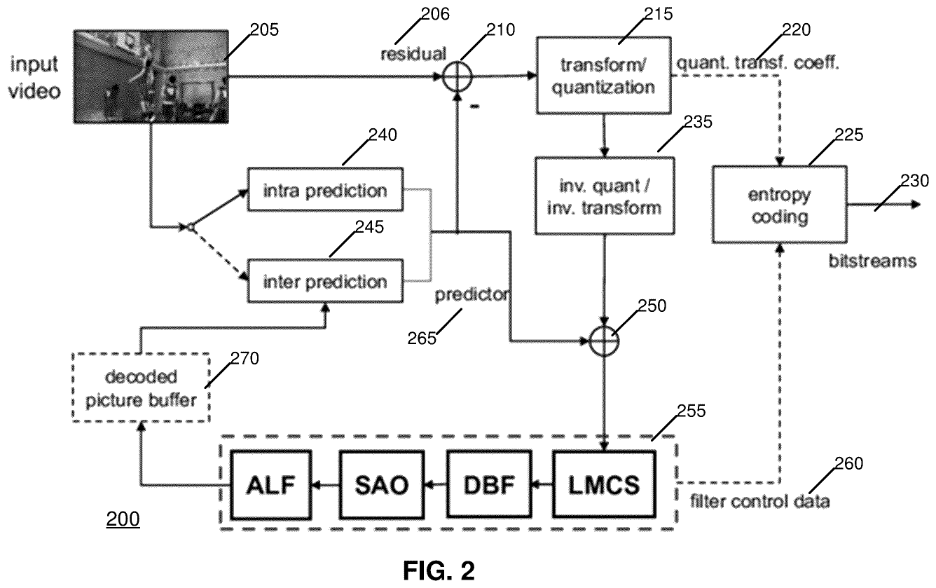

FIG. 2 illustrates an example of a VVC in-loop filter 200. Input video 205 is input (as residual 206) to an adder 210 and to an intra prediction block 240, and possibly to inter prediction block 245. The adder 210 adds the residual 206 to predictor output 265 from blocks 240 and 245, and the output goes to a transform/quantization block 215. Output of block 215 goes to an inverse quantization/inversion transform block 235, output of which goes to adder 250. The adder 250 adds the predictor output 265 to output of the block 235, and the output of the adder 250 goes to block 255, which has the following blocks in order: LMCS (luma mapping with chroma scaling); DBF (deblocking filter); SAO (Sample adaptive offset); and ALF (Adaptive loop filter). The output of block 255 goes to an optional decoded picture buffer 270, then to inter prediction block 245. Output (quantized transformed coefficients 220) of the transformation/quantization block 215 may also go to entropy coding block 225, which also accepts filter control data 260 as an output of block 255, and which produces bitstreams 230.

In-loop filters 200 play a critical role in the maintenance of compressed video quality, since they can not only improve the quality of the current frame but can also provide a higher quality reference for subsequent frames. Four processing steps (see block 255), namely a luma mapping with chroma scaling (LMCS) process, followed by a deblocking filter (DBF), an SAO filter, and an adaptive loop filter (ALF) are applied to the reconstructed samples before writing them into the decoded picture buffer 270. The DBF and SAO are similar to that of the HEVC standard, whereas LMCS and ALF are newly introduced in VVC.

In VVC, in-loop filtering consists of a fixed-order chain of three filters including deblocking filter (DBF), sample adaptive offset (SAO) filter, and adaptive loop filter (ALF). A block-based ALF is used in VVC, which comprises luma ALF, chroma ALF and cross-component ALF (CC-ALF). The ALF filter coefficients are either pre-defined and fixed in both encoder and decoder or adaptively signaled on a picture basis using an adaptation parameter set (APS). In order to enable merging of subpictures bitstreams (coded using independent encoder instances) into a single VVC-compliant picture without any ALF-APS identifiers conflict issue, the following techniques have been proposed:

Technique 1 (Disabled ALF): As a naïve method where no coordinated coding is required, ALF (i.e., both fixed ALF and ALF APS) is disabled to facilitate merging of different subpictures representations into a single picture at the cost of losing a substantial coding efficiency.

Technique 2 (Disabled ALF APS): the pre-defined fixed ALF is enabled, while the ALF APS usage is disabled for each subpicture, at the cost of disregarding the benefit of ALF parameter adaptation which comes with a coding efficiency.

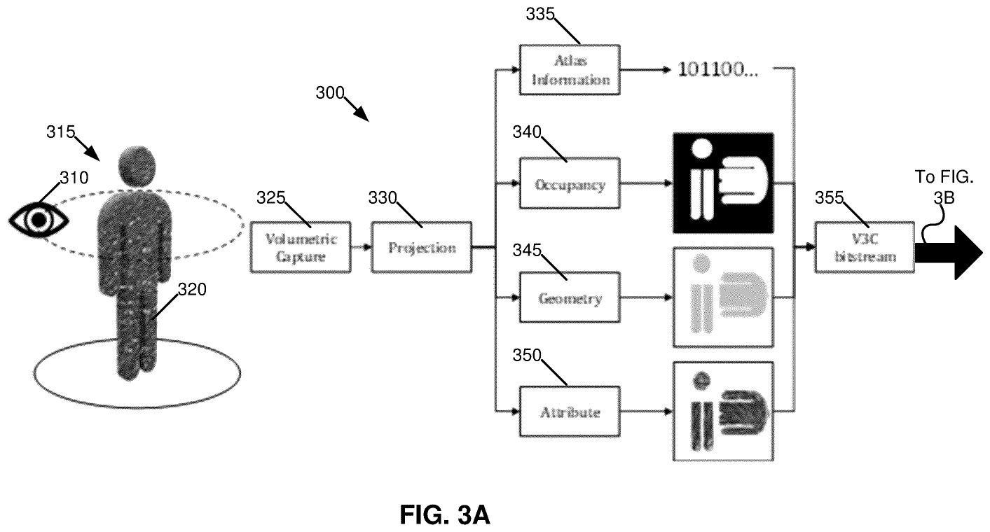

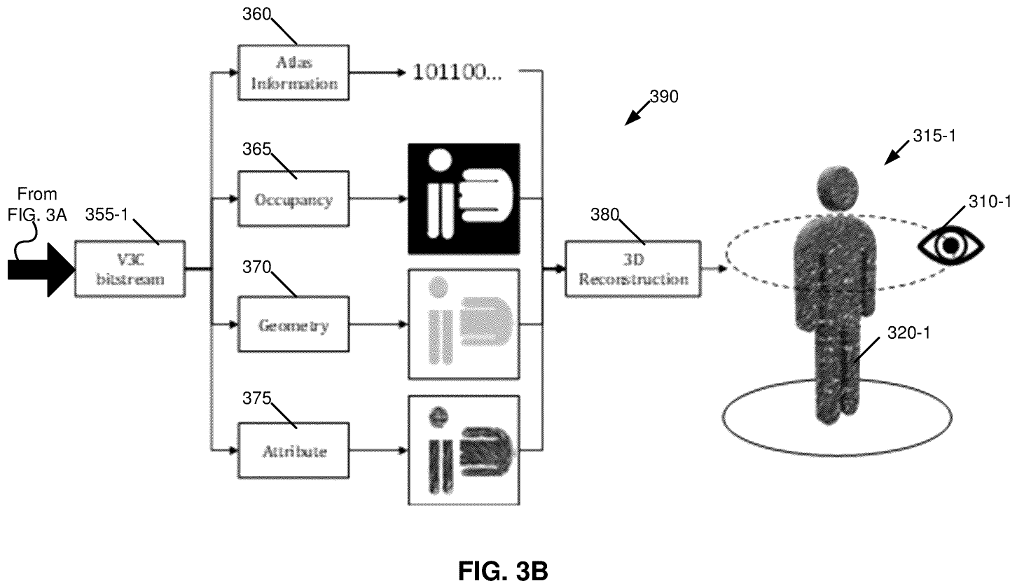

A further topic of interest is MPEG visual volumetric video-based coding (V3C). The V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g., texture or material information, of such 3D data. An example is shown in FIGS. 3A and 3B. Sec ISO/IEC 23090-5 (e.g., ISO/IEC 23090-5: 2022 (E), “Information technology—Coded Representation of Immersive Media—Part 5: Visual Volumetric Video-based Coding (V3C) and Video-based Point Cloud Compression (V-PCC)”, ISO/IEC JTC 1/SC 29/WG 07, 2022 Mar. 1).

In the example of FIG. 3A, an encoder 300 is illustrated where there is a capture of 3D media from volumetric capture 325 at a viewpoint 310 of a scene 315, which includes a human being 320. Output of the volumetric capture 325 is operated on by the projection component 330. There is first a conversion of such media from their corresponding 3D representation to multiple 2D representations, also referred to as V3C components, before coding such information. The projection component 330 converts 3D to 2D representations in streams of V3C components: occupancy component 340; geometry component 345; and attribute component 350. That is, such representations include the occupancy, geometry, and attribute components. The occupancy component 340 can inform a V3C decoder (as in FIG. 3B) of which samples in the 2D components are associated with data in the final 3D representation. The geometry component 345 contains information about the precise location of 3D data in space, while the attribute components 350 can provide additional properties, e.g., texture or material information, of such 3D data. 3Additional atlas information 335 is also included in the bitstream 355 to enable inverse reconstruction. The streams from blocks 335, 340, 345, and 350 are combined to become V3C bitstream 355.

FIG. 3B illustrates a decoder 390, which performs the reverse of many of the operations of FIG. 3A. The V3C bitstream 355-1 (e.g., in case there are errors in the bitstream 355) is split into its constituent component streams: atlas information 360; occupancy component 365; geometry component 370; and attribute component 375. The 3D reconstruction block 380 reconstructs the 3D media to reproduce a version of the 3D media at a viewpoint 310-1 of a scene 315-1, which includes a human being 320-1.

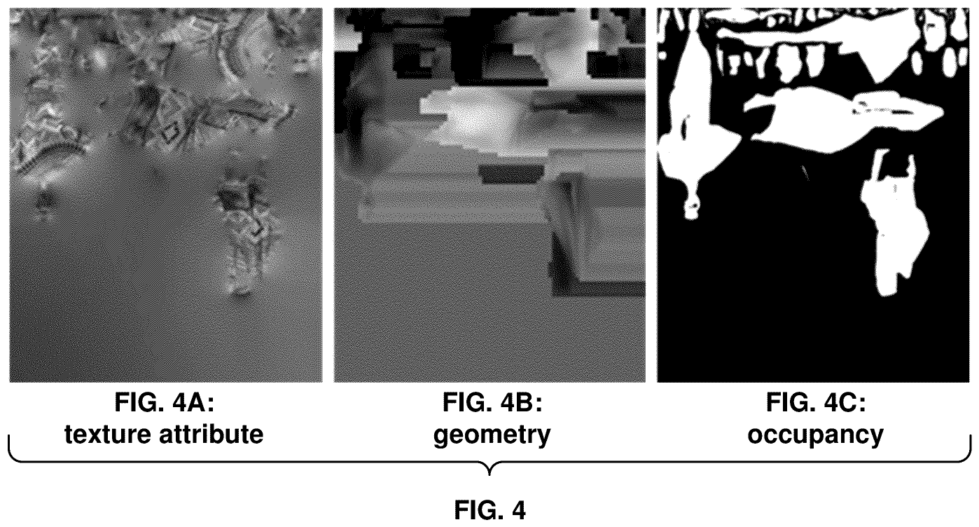

As stated previously, attributes, geometry, and texture are coded as 2D images in video sequences. To increase coding efficiency on the geometry and attribute video sequences, areas not intended for 3D reconstruction are padded (which reduces high frequency content at patch boundaries). Example frames are shown in FIG. 4, which is split into FIGS. 4A, 4B, and 4C, illustrates example V3C videos for texture attribute (FIG. 4A), geometry (FIG. 4B) and occupancy (FIG. 4C).

A V3C decoder 390 receives the three video bitstreams 365, 370, and 375, alongside a V3C atlas bitstream 360 and then reconstructs the volumetric video frame by frame as follows:
1. The decoder 390 reconstructs the patch positions in 3D space based on the atlas bitstream.
2. The decoder 390 reconstructs the patch shape according to the occupancy map signal.
3. The decoder 390 reconstructs the 3D positions of each point per patch based on the geometry video.
4. The decoder applies attributes to each point, e.g., texture color.

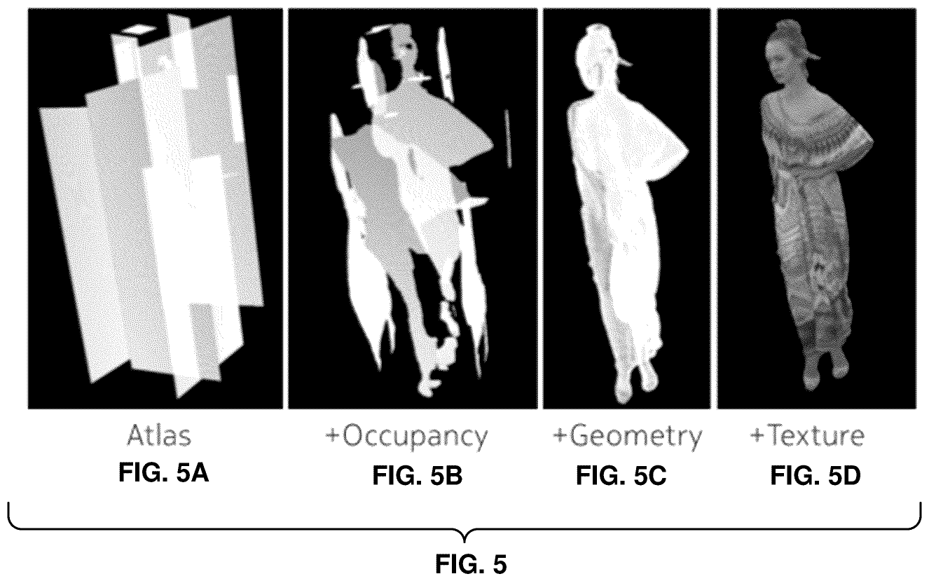

The different stages of this process are visualized in FIG. 5. FIG. 5, split over FIGS. 5A, 5B, 5C, and 5D, illustrates parts of a V3C V-PCC decoding process. FIG. 5A illustrates step 1 above and the application of the atlas bitstream; FIG. 5B illustrates step 2 above and the application of the occupancy bitstream; FIG. 5C illustrates step 3 above and the application of the geometry bitstream; and FIG. 5D illustrates step 4 above and the resultant texture.

A further additional topic is Video Coding for Machines (VCMs). Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, or the like. Example use cases and applications are self-driving cars, video surveillance cameras and public safety, smart sensor networks, smart TV and smart advertisement, person re-identification, smart traffic monitoring, drones, or the like. This may raise the following question: when decoded data are consumed by machines, shouldn't we aim at a different quality metric—other than human perceptual quality—when considering media compression in inter-machine communications? Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCMs).

It is possible that the receiver-side device has multiple “machines” or neural networks (NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

Also, please notice that we use the term “receiver-side” or “decoder-side” to refer to the physical entity or device which contains one or more machines, and runs these one or more machines on some encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

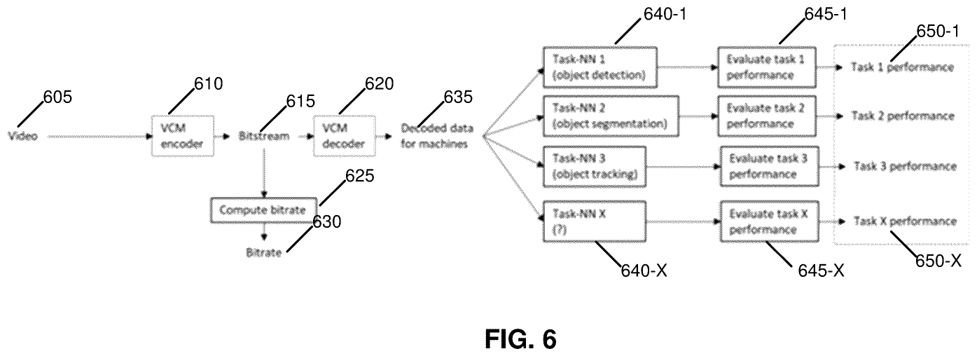

FIG. 6 is a general illustration of the pipeline of Video Coding for Machines. A VCM encoder 610 encodes the input video 605 into a bitstream 615. A bitrate 630 may be computed 625 from the bitstream in order to evaluate the size of the bitstream. A VCM decoder 620 decodes the bitstream 615 output by the VCM encoder 610. The output of the VCM decoder is referred in the figure as “Decoded data for machines” 635. This data may be considered as the decoded or reconstructed video. However, in some implementations of this pipeline, this data may not have same or similar characteristics as the original video, which was input to the VCM encoder. For example, this data may not be easily understandable by a human by simply rendering the data onto a screen. The output of VCM decoder 620 is then input to one or more task neural networks, in this example task-NNs 640-1 to 640-X. In the figure, for the sake of illustrating that there may be any number of task-NNs, there are three example task-NNs, and a non-specified one (Task-NN X). The goal of VCM is to obtain a low bitrate while guaranteeing that the task-NNs 640 still perform well in terms of the evaluation metric 650-1 to 650-X (by the evaluate task performance 645-1 through 645-X) associated to each task.

When a conventional video encoder, such as a H.266/VVC encoder, is used as a VCM encoder 610, one or more of the following approaches may be used to adapt the encoding to be suitable to machine analysis tasks:
a) One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas (e.g., blocks) may be formed to cover the ROI boundaries. The detected ROIs (or rectangular areas, likewise) may be used in one or more of the following ways:
i) The quantization parameter (QP) may be adjusted spatially in a manner that ROIs are encoded using finer quantization step size(s) than other regions. For example, QP may be adjusted CTU-wise.
ii) The video is preprocessed to contain only the ROIs, while the other areas are replaced by one or more constant sample values or removed.
iii) A grid is formed in a manner that a single grid cell covers a ROI. Grid rows or grid columns that contain no ROIs are downsampled as preprocessing to encoding.
b) A quantization parameter of the highest temporal sublayer(s) is increased (i.e., coarser quantization is used) when compared to practices for human-watchable video.
c) The original video is temporally downsampled as preprocessing prior to encoding. A frame rate upsampling method may be used as postprocessing subsequent to decoding, if machine analysis at the original frame rate is desired.
d) A filter is used to preprocess the input to the conventional encoder. The filter may be a machine-learning-based filter, such as a convolutional neural network.

Another topic of interest is region of interest (ROI) video coding. When encoding an input video for a certain application or purpose, some regions in the input video may be more important than other regions. For example, in a surveillance system, the regions that contain human beings may be important for the application. A region of interest (ROI) is referred to as a foreground region. A region that does not belong to regions of interest is referred to as a background region. The foreground regions may be regions that contain certain classes of objects or regions that are considered salient. ROI-enabled video codec may encode an input video in a manner that foreground regions are reconstructed with high quality and background regions are reconstructed with low quality.

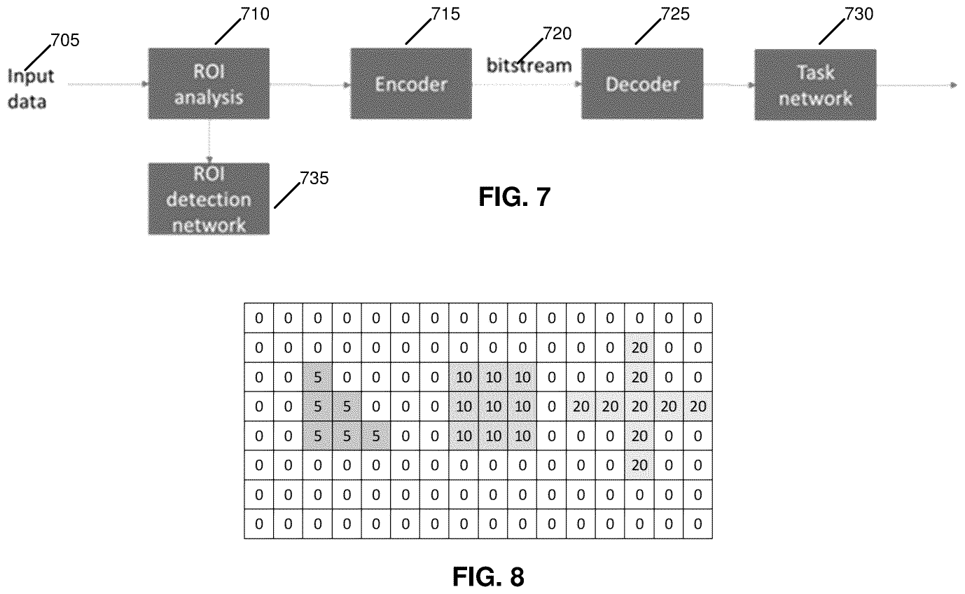

FIG. 7 shows an ROI-enabled video codec for machines where the foreground regions are detected using an ROI detection network 735. The ROI detection network 735 may be a computer vision task network, for example, or an object detection or instance segmentation network. The input data 705 may be processed using the ROI analysis 710 and the processed data is passed to the encoder 715. The ROI information may be used to determine encoding parameters for the encoder. For example, a coding unit that falls into a foreground region may be encoded using a low quantization parameter, resulting in a high-quality reconstruction. Meanwhile, a coding unit that falls into a background region may be encoded using a high quantization parameter, resulting in a low-quality reconstruction.

The encoder 715 may encode the ROI information and transfer the ROI information (as bitstream 720) to the decoder in or along the bitstream 720. The decoder 725 may use the received ROI information to decode the bitstream and output the reconstructed data. The reconstructed data may be consumed by humans or one or more task networks 730.

ROI information may contain, but is not limited to the following:
a) The coordinates and size of each foreground region.
b) A mask representation of the foreground and background regions, such as a monochromatic mask image where certain sample value range represents foreground, and another certain value range represents background. In another example, distinct value ranges may be used for different foreground objects.
c) Semantic information about the foreground and/or background regions.
d) Confidence of the semantic information about the foreground and/or background regions.
e) Saliency information about the foreground and/or background regions.

The following is background on region of interest video coding (JVET-AD0175). See also JVET-AD0175, Jie Chen, “AHG8/AHG9: On object mask auxiliary picture and object mask information SEI message for VSEI and HEVC”, Joint Video Experts Team (JVET) of ITU-T SG 16 WP 3 and ISO/IEC JTC 1/SC 29, 30th Meeting, Antalya, TR, 21-28 Apr. 2023. Usually, an object mask is a binary matrix wherein “0” represents background and “1” represents the foreground. But for the auxiliary picture with luma sample bit-depth equal to BitDepthY, there are 1<<BitDepthY different values for each sample. To distinguish different masks within one picture, JVET-AD0175 uses the sample value of auxiliary picture as the ID of the mask. That is to say, in the auxiliary picture, the samples with the same value form a mask. And the regions with different sample values represent different masks. For example, as shown in FIG. 8, this is a 16×8 auxiliary picture, and numbers in the figure denote the sample values. So, there are four different masks in the auxiliary. The samples with value 5 form a special mask with ID equal to 5; the samples with value 10 form a mask with ID equal to 10; the samples with value 20 form a mask with ID equal to 20; and the samples with value 0 form a mask with ID equal 0 (the special mask could be labelled as “background”).

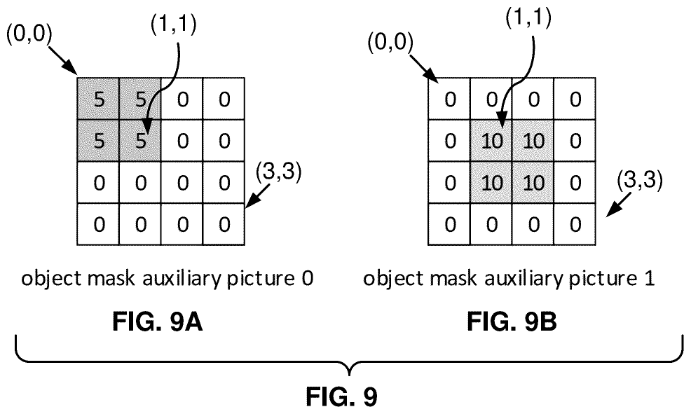

As the mask can be overlapped, multiple object mask auxiliary pictures (one auxiliary picture in one layer) can used for one primary picture to handle an overlapping case. In that case, the samples with same position but in the different mask pictures could belong to different masks overlapped with each other. For example, as shown in FIG. 9, there are two 4×4 object mask auxiliary pictures. FIG. 9 has two parts, FIGS. 9A and 9B, where an object mask auxiliary picture 0 (zero) is shown in FIG. 9A and an object mask auxiliary picture 1 (one) is shown in FIG. 9B. In the picture 0 of FIG. 9A, the top-left 2×2 block is a mask with ID 5, and in the picture 1 in FIG. 9B, the center 2×2 block is a mask with ID 10. When a decoder receives these two auxiliary pictures, it is clear that there are two masks being overlapped at position (1,1), if (0,0) is the highest and left-most position and (3,3) is the lowest and right-most position. The overlap causes a conflict at location (1,1). While this conflict can be addressed, it adds additional processing and time requirements.

Now that information for region of interest video coding (JVET-AD0175) has been described, additional information is described. Modern hybrid video codecs are primarily designed to optimize video quality for human viewers and may not be optimized for efficiently encoding piece-wise smooth content. In particular, the sharp transitions between smooth content areas pose a significant challenge for these codecs, leading to higher bitrates needed to minimize reconstruction distortion. While this approach suffices for videos intended for human consumption, there is an increasing demand for scenarios where the encoded video is not directly intended for human viewing. These scenarios include depth/geometry videos for 3D-video and visual volumetric video-based coding (V3C), ROI masks for Video Coding for Machines (VCM), object masks for visual AI tasks, and more.

In such cases, the emphasis shifts towards the efficient coding of piece-wise smooth video content. To cater to the needs of these emerging use cases and to make current and next-generation video codecs more versatile beyond human video consumption, it becomes important to enhance video coding techniques specifically tailored for efficiently handling piece-wise smooth video content. By doing so, video codecs can better adapt to a broader range of applications and maximize the utility of video data in various fields beyond traditional human viewership.

The examples herein disclose video encoder adaptations targeted at piece-wise smooth video content. An overview is provided now, and more details are provided below.

Multiple examples are briefly presented here and are categorized generally into categories as follows: (1) preprocessing; (2) encoder operations; (3) encoder decisions; and (4) signaling. This overview is described in part by FIG. 10, which is a flow diagram of coding adaptations for piece-wise smooth video content.

One example of a method for category (1), preprocessing, includes in block 1110, by an encoder, receiving a picture, e.g., on a discrete two-dimensional pixel grid. The method includes (see block 1120) identifying, by the encoder, whether the picture has areas containing smooth content. This may be performed by identifying whether the picture has a piece-wise smooth value distribution, and, responsive to the picture having a piece-wise smooth value distribution, identifying smooth areas in the picture. It is noted that the terms “smooth area” and “smooth content” are considered to be the same herein. It is further noted that a determination that a block does not have smooth content means the block has mixed content. For instance, if there are blocks 1 and 2, and block 1 is determined (and therefore identified) to have smooth content, then block 2 has mixed content. It is also possible to determine blocks that have mixed content, and blocks that do not have mixed content are identified to have smooth content. For the scenario of blocks 1 and 2, where block 2 is determined to have mixed content, then block 1 has smooth content. Additional examples of the preprocessing 1106 for category (1) are illustrated in FIG. 10A and are described below.

Another (e.g., second) example, for category (2), the encoder, is a method performed by an encoder included the following. The encoder encodes (see block 1125) a bitstream comprising at least one coded picture, wherein the following examples may or may not be used:
a) information according to the previous example may be provided through external means (this is referred to as guided coding); or
b) information according to the previous example may be derived during the encoding process (this is referred to as in-loop/unguided coding); and
c) information according to the previous example is used to adapt encoder decisions.

Additional examples of the encoder operations 1107 of category (2) are illustrated in FIG. 10B and are described below.

The following (e.g., third) method, for category (3), encoder decisions, is an example based on the second example. The encoder performs (see block 1130) one or more adaptations to encoding decisions made in the encoding process based on the identified areas containing one of the smooth content or the mixed content. In one example, encoder adaptations, e.g., for efficiently encoding piece-wise smooth content, may comprise one or more of the following:
a) skipping further block partitioning;
b) lowering or increasing QP offset;
c) skipping residual coding;
d) skipping motion estimation;
e) skipping in-loop-filter; or
f) adapting in-loop-filter.

Additional examples of the encoder decisions 1107 of category (3) are illustrated in FIG. 10C and are described below.

Another method, for category (4), signaling, can be applied to the second and third methods. In this method, signaling (see block 1140) may include signaling one or more encoder adaptations in or along a bitstream comprising the video signal. The decoder, in response to reception of the signaling of the encoder adaptation(s), would then take appropriate action based on the adaptation(s). Additional examples of the signaling 1108 of category (4) are illustrated in FIG. 10D and are described below.

Now that an overview has been described, more details are described. In this document, the term block may refer to a CU, PU, TU, CTU, slice or sub-picture.

More details about category (1), preprocessing, are provided. These details are provided using FIG. 10A, which is a flow diagram describing additional examples of the preprocessing 1106 for category (1) from FIG. 10.

In one embodiment, see block 1111, a smoothness test is performed. In this example, a picture is divided into blocks and individual blocks are checked for the presence of smooth value distribution. For each block, a decision is made if this block contains either (A) fully smooth content (referred to primarily as “smooth content” herein), or (B) mixed smooth and transitional content (referred to typically as “mixed content” herein), such as edges or high-frequency content. The decision as to whether a block is smooth content or mixed content may be performed by any of blocks 1113 to 1125, as examples.

In one embodiment, see block 1113, this decision may be made by analyzing a gradient between all adjacent pixel values. If the gradient between one or more pixel values of the block is larger than a certain threshold, e.g., 1 (one), then the block is classified as (B) mixed content.

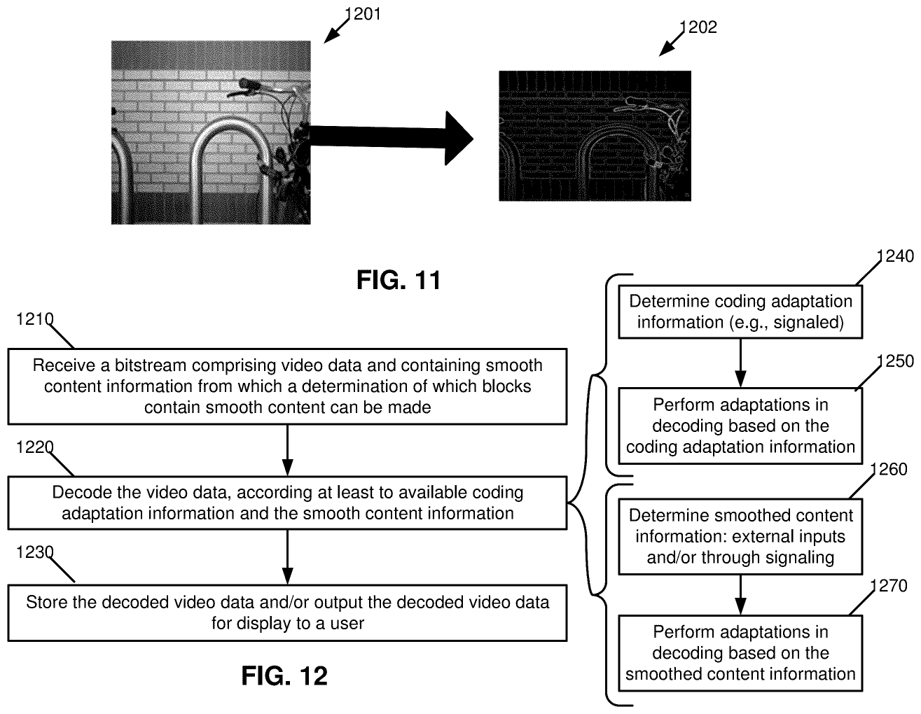

In one embodiment, see block 1115, this decision may be made by applying a 2D-Sobel operator to the block (horizontally and/or vertically). If the resulting operator output image has any pixel value above a certain threshold, e.g., 1 (one) for a normalized output, then the block is classified as (B) mixed content. An example of such an operation on a full image is shown in FIG. 11. FIG. 11 illustrates an input image 1201 and an output image 1202 after applying a 2D-Sobel operator to the block of input image 1201.

In one embodiment, see block 1117, this decision may be made by analyzing a derivate of the gradient between all adjacent pixel values. If the derivates are close to zero or a gradual value change, then the block is classified as (A) smooth content.

In one embodiment, see block 1119, this decision may be made by analyzing pixels in the frequency domain. A Fourier transform, e.g., DCT, DST, is applied to the block and the frequency components are examined. Smooth content (A) will exhibit lower-frequency components, while mixed content (B) will have higher-frequency components. It is noted that is it hard to provide exact numbers between lower- and higher-frequency components, because a block can have a wide range of these components, depending on what information is in the block (relative to other blocks). There are, however, techniques that can be used to differentiate between the two for a given block, such as using a threshold to differentiate between lower- and higher-frequency components, e.g., when comparing results from two blocks. This embodiment is particularly useful in video coding, as Fourier transforms are already applied to the blocks anyway during the coding process.

In one embodiment, see block 1121, this decision may be made by histogram analysis. All pixel values of the block are grouped in bins of a histogram. If the histogram has a smooth value distribution, then the block is classified as (A) smooth content.

In one embodiment, see block 1123, this decision may be made by analyzing variance of all pixel values. If the variance of pixel values for the block is above a certain threshold, then the block is classified as (B) mixed content.

In one embodiment, see block 1125, one or more of the above-mentioned smoothness tests from 1113 to 1123 are combined together. FIG. 10B is a flow diagram describing additional examples of the encoder operations 1106 for category (2) from FIG. 10;

More details for category (2), the encoder operations, are provided now.

In one embodiment, see block 1126, an encoder receives an image and identifies blocks with smooth content by performing any of the above-mentioned smoothness tests during the encoding process of a block. This approach is called un-guided.

In another embodiment, see block 1127, the encoder receives external guidance information suitable to identify blocks of smooth content within said picture. Such information could for example include:
a) (inverted) ROI masks (block 1127-a);
b) occupancy maps (block 1127-b);
c) (inverted) object masks (block 1127-c).

It is noted that “(inverted)” means both inverted and non-inverted (e.g., normal) could be used. For instance, “(inverted) ROI masks” means “ROI masks or inverted ROI masks”.

In one embodiment, see block 1128, the encoder encodes a block that the encoder has identified to contain smooth content only (A). Based on this information, the encoder adapts the encoding decisions for this coding block.

In one embodiment, see block 1129, the encoder encodes a block that the encoder has identified to contain mixed content only (B). Based on this information the encoder adapts the encoding decisions for this coding block.

More details for category (3), encoder decisions, are provided now. FIG. 10C is a flow diagram describing additional examples of the encoder decisions 1108 for category (3) from FIG. 10.

In one embodiment, see block 1131, the encoder skips any further block sub-partitioning once a block has been identified as (A) smooth content.

In one embodiment, see block 1132, the encoder raises the QP offset for blocks identified as smooth content. This adaptation provides gains in coding efficiency for smooth content while preserving reconstruction quality overall. As is known, increase QP offset causes quality to reduce, but provides better compression.

In one embodiment, see block 1133, the encoder lowers the QP offset for blocks identified as mixed content. This adaptation provides improved reconstruction quality for mixed content.

In one embodiment, see block 1134, the encoder skips residual coding for blocks identified as smooth content. This adaptation provides gains in coding efficiency for smooth content while preserving reconstruction quality overall.

In one embodiment, see block 1135, the encoder deactivates motion estimation for blocks identified as smooth content. This adaptation provides improved encoding times at constant reconstruction quality.

In one embodiment, see block 1136, the encoder deactivates certain in-loop filters for blocks identified as smooth content, such as one or more of the following (see block 1136-1):
a) luma mapping with chroma scaling (LMCS);
b) performing an encoding process, followed by a deblocking filter (DBF) (or, equivalently, deactivating a DBF that follows an encoding process);
c) sample adaptive offset filter (SAO);
d) adaptive loop filter (ALF);
e) cross-component adaptive loop filter (CCALF),
f) cross-component sample adaptive offset filter (CCSAO),
g) neural network-based filter;
h) Bilateral filter;
i) Loop Restoration filters (such as a Wiener filter and self-guided filter); or
j) constrained directional enhancement filter (CDEF).

In one embodiment, see block 1137, the encoder adapts the filter settings for certain in-loop filter for blocks identified as smooth content, such as one or more of the following (see block 1137-1):
a) adaptive loop filter (ALF);
b) cross-component adaptive loop filter (CCALF);
c) cross-component sample adaptive offset filter (CCSAO);
d) neural network-based filter;
e) loop restoration filters (such as Wiener filter and self-guided filter); or
f) constrained directional enhancement filter (CDEF).

In one embodiment, see block 1138, one or more of the above-mentioned adaptations are combined together.

More details about for category (4), signaling, are provided now. Refer to FIG. 10D, which is a flow diagram describing additional examples of the signaling for category (4) from FIG. 10.

Embodiments related to categories (1) and (2) do not require signaling.

Certain embodiments related to category (3) could use signaling of the applied encoding adaptations to the decoder, e.g., if certain in-loop-filter should be applied or not.

In an embodiment, see block 1141, an encoder indicates, in or along a bitstream, the adaptations applied to (A) smooth content or (B) mixed content blocks, such as one or more of the following (see block 1141-1):
a) Deactivation of certain (e.g., first) in-loop filter(s); or
b) Modifications to certain (e.g., second) in-loop filter(s).

In one embodiment, see block 1143, the encoder has to perform the smoothness analysis described in category (1) on the reconstructed content to identify smooth blocks. The smoothness analysis approach and parameters may be signaled in or along the bit stream, for example as an SEI message, for subsequent use by the decoder. However, this approach could have some amount of error, as it is applied on reconstructed content and the encoder adaptations performed during the encoding process may affect the smoothness identification for the reconstructed content incorrectly.

In another embodiment, see block 1145, the encoder receives external smoothness information, as described in category (2) to make its decision (from reference 1105). Such content could either come from the same sources as described in category (2) (e.g., guided coding, unguided coding, or information according to the previous example is used to adapt encoder decisions), or be a (e.g., newly) generated smoothness map created by the encoder as output of the encoder smoothness analysis. Such an approach is more reliable, however it requires additional data to be received. Such an approach works well when this additional data is required by the decoder anyway, for example in the form of V3C occupancy maps.

In an embodiment, see block 1147, an encoder indicates, in or along a bitstream, the source of smoothness information, such as (see block 1147-1):
a) individual video streams;
b) separate layers for multi-layer coding;
c) separate sublayers;
d) separate pictures in a temporally interleaved manner in the same coded layer video sequence; or
e) separate constituent frames in spatially frame-packed video.

The decoder, in response to receiving the indication(s), then determines the source of the smoothness information and performs decoding accordingly.

In another embodiment, see block 1149, the encoder adaptations are signaled for each block where they are taken. This approach does not require additional data to be received, but instead requires additional signaling in each block. For example, as follows in this part of VVC specifications (section 7.3.11.5, Coding unit syntax, of ITU-T H.266, “SERIES H: AUDIOVISUAL AND MULTIMEDIA SYSTEMS-Infrastructure of audiovisual services-Coding of moving video”, Versatile video coding, April 2022):

| | Descriptor |
|---|---|
| coding_unit( x0, y0, cbWidth, cbHeight, cqtDepth, treeType, modeType ) { | |
| if( sh_slice_type = = I && ( cbWidth > 64 \| \| cbHeight > 64 ) ) | |
| modeType = MODE_TYPE_INTRA | |
| chType = treeType = = DUAL_TREE_CHROMA ? 1 : 0 | |
| if( sh_slice_type != I \| \| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \| \| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != I && | |
| !( cbWidth = = 4 && cbHeight = = 4 ) && modeType = = | |
| MODE_TYPE_ALL ) | |
| smooth_flag | u(1) |
| pred_mode_flag | ae(v) |
| ... | ... |

Setting smooth_flag equal to 0 specifies that the current coding unit is coded as smooth content mode. Setting smooth_flag equal to 1 specifies that the current coding unit is coded as mixed content mode.

In yet another embodiment, see block 1151, a (e.g., new) prediction mode is introduced to represent the coding of smooth blocks. This is an example of an embodiment for signaling of smooth content adaptations.

For example, as follows in VVC specifications:

| | Descriptor |
|---|---|
| coding_unit( x0, y0, cbWidth, cbHeight, cqtDepth, treeType, modeType ) { | |
| if( sh_slice_type = = I && ( cbWidth > 64 \| \| cbHeight > 64 ) ) | |
| modeType = MODE_TYPE_INTRA | |
| chType = treeType = = DUAL_TREE_CHROMA ? 1 : 0 | |
| if( sh_slice_type != I \| \| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \| \| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != I && | |
| !( cbWidth = = 4 && cbHeight = = 4 ) && modeType = = | |
| MODE_TYPE_ALL ) | |
| pred_mode_flag | ae(v) |
| if( ( ( sh_slice_type = = I && cu_skip_flag[ x0 ][ y0 ] = =0 ) \| \| | |
| ( sh_slice_type != I && ( CuPredMode[ chType ][ x0 ][ y0 ] != | |
| MODE_INTRA \| \| | |
| ( ( ( cbWidth = = 4 && cbHeight = = 4 ) \| \| modeType = = | |
| MODE_TYPE_INTRA ) | |
| && cu_skip_flag[ x0 ][ y0 ] == 0 ) ) ) ) && | |
| cbWidth <= 64 && cbHeight <= 64 && modeType != | |
| MODE_TYPE_INTER && | |
| sps_ibc_enabled_flag && treeType != DUAL_TREE_CHROMA ) | |
| pred_mode_ibc_flag | ae(v) |
| } | |
| if( CuPredMode[ chType ][ x0 ][ y0 ] = = MODE_INTRA && | |
| sps_palette_enabled_flag && | |
| cbWidth <= 64 && cbHeight <= 64 && cu_skip_flag[ x0 ][ y0 ] = = 0 | |
| && | |
| modeType != MODE_TYPE_INTER && ( ( cbWidth * cbHeight ) > | |
| ( treeType != DUAL_TREE_CHROMA ? 16 : 16 * SubWidthC * | |
| SubHeightC ) ) && | |
| ( modeType != MODE_TYPE_INTRA \| \| treeType != | |
| DUAL_TREE_CHROMA ) ) | |
| pred_mode_smooth_flag | ae(v) |
| pred_mode_plt_flag | ae(v) |
| ... | ... |

The pred_mode_smooth_flag specifies the use of smooth coding mode in the current coding unit. Setting pred_mode_smooth_flag equal to 1 indicates that smooth coding mode is applied in the current coding unit. Setting pred_mode_smooth_flag equal to 0 indicates that smooth coding mode is not applied in the current coding unit. When pred_mode_smooth_flag is not present, it may be inferred to be equal to 0.

In the example from section 7.3.11.5, a simple flag was used. Meanwhile, for the previous example with the pred_mode_smooth_flag, this involves a prediction mode. Decoder embodiments are as follows. In one embodiment, a decoder receives a bitstream, containing smooth content information, e.g., in the form of external inputs, or through signaling as disclosed above. The decoder decodes the video data, according to available coding adaptation information.

More detail is illustrated in FIG. 12, which is a flow diagram of part of a decoding process. The decoder in this example is implemented by an apparatus and the flow of FIG. 12 is performed as part of a decoding process. In block 1210, the decoder receives a bitstream comprising video data and containing smooth content information from which a determination of which blocks contain smooth content can be made. The decoder in block 1220 decodes the video data, according at least to available coding adaptation information and the smooth content information. In block 1230, the decoder stores the decoded video data and/or output the decoded video data for display to a user.

Block 1220 can include any of the blocks in FIGS. 10A, 10B, 10C, and 10D that are not solely performed on the encoder. For instance, for FIG. 10C, blocks 11335 and 1136-1 (b) are performed solely on the encoder, but all the other blocks may be acted on by the decoder. Furthermore, block 1220 can include blocks 1240/1250 and 1260/1270. In block 1240, the coding information (e.g., which could be signaled) is determined, and in block 1250, adaptations are performed in decoding based on the coding adaptation information. For instance, in blocks 1141 and 1141-1 of FIG. 10D, the deactivation of certain in-loop filter(s) can be signaled by the apparatus performing the encoding, and then the decoder would deactivate the certain in-loop filter(s).

In block 1260, the decoder determines smoothed content information, e.g., via the external inputs and/or through signaling as described above. In block 1270, the decoder performs adaptations in decoding based on the smoothed content information. For instance, in blocks 1147 and 1147-1 of FIG. 10D, a source of smoothness information can be signaled or otherwise indicated, and the decoder would use the source to determine the smoothed content information, and then perform adaptations similar to any of those in FIG. 10C that are applicable to decoding.

Turning to FIG. 13, this figure is an example of a block diagram of an apparatus suitable for implementing any of the encoders or decoders described herein. The apparatus 1380 includes circuitry comprising one or more processors 1320, one or more memories 1325, one or more transceivers 1330, one or more network (N/W) interface(s) (I/F(s)) 1355 and user interface (UI) circuitry and elements 1357, interconnected through one or more buses 1327. Depending on implementation, some apparatus may not have all of the circuitry. For example, an apparatus 1380 might not have UI circuitry and elements 1357. An apparatus may have additional circuitry, not described here. FIG. 13 is presented merely as an example.

Each of the one or more transceivers 1330 includes a receiver, Rx, 1332 and a transmitter, Tx, 1333. The one or more buses 1327 may be address, data, and/or control buses, and may include any interconnection mechanism, such as a series of lines on a motherboard or integrated circuit, fiber optics or other optical communication equipment, and the like. The one or more transceivers 1330 are connected to one or more antennas 1305, and may communicate using wireless link 1311.

The one or more memories 1325 include computer program code 1323. The apparatus 1380 includes a control module 1340, comprising one of or both parts 1340-1 and/or 1340-2. The control module 1340 may implement an encoder, a decoder, or a codec, which implements both encoding and decoding. The control module itself may be implemented in a number of ways. The control module 1340 may be implemented in hardware as control module 1340-1, such as being implemented as part of the one or more processors 1320. The control module 1340-1 may be implemented also as an integrated circuit or through other hardware such as a programmable gate array. In another example, the control module 1340 may be implemented as control module 1340-2, which is implemented as computer program code (having corresponding instructions) 1323 and is executed by the one or more processors 1320. For instance, the one or more memories 1325 store instructions that, when executed by the one or more processors 1320, cause the apparatus 1380 to perform one or more of the operations as described herein. Furthermore, the one or more processors 1320, one or more memories 1325, and example algorithms (e.g., as flowcharts and/or signaling diagrams), encoded as instructions, programs, or code, are means for causing performance of the operations described herein.

The network interface(s) (N/W I/F(s)) 1355 are wired interfaces communicating using link(s) 1356, which could be fiber optic or other wired interfaces. The apparatus 1380 could include only wireless transceiver(s) 1330, only N/W I/Fs 1355, or both wireless transceiver(s) 1330 and N/W I/Fs 1355.

The apparatus 1380 may or may not include UI circuitry and elements 1357. These could include a display such as a touchscreen, speakers, or interface elements such as for headsets. For instance, an apparatus 1380 of a smartphone would typically include at least a touchscreen and speakers. The UI circuitry and elements 1357 may also include circuitry to communicate with external UI elements (not shown) such as displays, keyboards, mice, headsets, and the like.

The computer readable memories 1325 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 1325 may be means for performing storage functions. The processors 1320 may be of any type suitable to the local technical environment, and may include one or more of general-purpose computers, special purpose computers, microprocessors, digital signal processors (DSPs) and processors based on a multi-core processor architecture, as non-limiting examples. The processors 1320 may be means for performing functions, such as controlling the apparatus 1380, and other functions as described herein.

Without in any way limiting the scope, interpretation, or application of the claims appearing below, a technical effect and/or advantage of one or more of the example embodiments disclosed herein is improved coding gains for smooth content or optional improved reconstruction gain for mixed content. Another technical effect and/or advantage of one or more of the example embodiments disclosed herein is an initial implementation of parts of the disclosed approach provides significant coding gains as shown above in accordance with FIG. 10.

The following are additional examples.

Example 1. A method, comprising: receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

Example 2. The method according to example 1, wherein identifying whether the picture has a piece-wise smooth value distribution comprises: identifying whether the picture has a piece-wise smooth value distribution; and identifying, responsive to the picture having a piece-wise smooth value distribution, smooth blocks in the picture.

Example 3. The method according to one of examples 1 or 2, wherein identifying whether the picture has a piece-wise smooth value distribution comprises performing a smoothness test comprising: dividing the picture into blocks; checking individual blocks for a presence of smooth value distribution; and deciding, for the individual blocks, whether this block contains either fully smooth content as the smooth content, or mixed smooth and transitional content as mixed content.

Example 4. The method according to example 3, wherein the decision is made at least by using a smoothness test analyzing a gradient between all adjacent pixel values in a block, and in response to the gradient between one or more pixel values of the block being larger than a threshold, then the block is classified as containing mixed content.

Example 5. The method according to example 3, wherein the decision is made at least by using a smoothness test applying a two-dimensional Sobel operator to the block horizontally, vertically or both horizontally and vertically, and in response to a resulting output image having any pixel value above a threshold, then the block is classified as containing mixed content.

Example 6. The method according to example 3, wherein the decision is made at least by using a smoothness test analyzing a derivate of a gradient between all adjacent pixel values, and in response to derivates being close to zero or a gradual value change, then the block is classified as smooth content.

Example 7. The method according to example 3, wherein the decision is made at least by using a smoothness test analyzing pixels in a frequency domain, wherein smooth content exhibits lower-frequency components, while mixed content exhibits higher-frequency components.

Example 8. The method according to example 3, wherein the decision is made at least by using a smoothness test performing a histogram analysis wherein all pixel values of the block are grouped in bins of a histogram, and in response to the histogram having a smooth value distribution, then the block is classified as smooth content.

Example 9. The method according to example 3, wherein the decision is made at least by using a smoothness test analyzing variance of all pixel values in a block, and in response to the variance of pixel values for the block being above a threshold, then the block is classified as containing mixed content.

Example 10. The method according to any of examples 3 to 9, wherein one or more of the smoothness tests are combined.

Example 11. The method according to any of examples 3 to 9, wherein the encoder receives external guidance information suitable to identify blocks of smooth content within the picture, and the external guidance information comprises: one of ROA masks or inverted ROI masks; occupancy maps; or one of object masks or inverted object masks.

Example 12. The method according to any of examples 1 to 11, wherein the encoding encodes a block that has been identified to contain smooth content only; and the performing the one or more adaptations comprises adapting the encoding decisions for this coded block.

Example 13. The method according to any of examples 1 to 12, wherein the encoding encodes a block that has identified to contain mixed content only; and the performing the one or more adaptations comprises adapting the encoding decisions for this coded block.

Example 14. The method according to any of examples 1 to 13, wherein the performing the one or more adaptations comprises skipping any further block sub-partitioning once a block has been identified as smooth content.

Example 15. The method according to any of examples 1 to 13, wherein the performing the one or more adaptations comprises raising quantization parameter offsets for corresponding blocks identified as smooth content.

Example 16. The method according to any of examples 1 to 13, wherein the identifying the picture has blocks containing smooth content further identifies blocks containing mixed content, wherein the performing the one or more adaptations comprises lowering quantization parameter offsets for corresponding blocks identified as containing mixed content.

Example 17. The method according to any of examples 1 to 13, wherein the performing the one or more adaptations comprises skipping residual coding for blocks identified as containing smooth content.

Example 18. The method according to any of examples 1 to 13, wherein the performing the one or more adaptations comprises deactivating motion estimation for blocks identified as containing smooth content.

Example 19. The method according to any of examples 1 to 13, wherein the performing the one or more adaptations comprises deactivating certain in-loop filters for blocks identified as smooth content, comprising deactivating one or more of the following: luma mapping with chroma scaling (LMCS); a deblocking filter (DBF) that follows an encoding process; a sample adaptive offset filter (SAO); an adaptive loop filter (ALF); a cross-component adaptive loop filter (CCALF), a cross-component sample adaptive offset filter (CCSAO), a neural network-based filter; a bilateral filter; a loop restoration filter; or a constrained directional enhancement filter (CDEF).

Example 20. The method according to any of examples 1 to 13, wherein the performing the one or more adaptations comprises adapting filter settings for certain in-loop filters for blocks identified as smooth content, comprising adapting filter settings for one or more of the following: an adaptive loop filter (ALF); a cross-component adaptive loop filter (CCALF); a cross-component sample adaptive offset filter (CCSAO); a neural network-based filter; one or more loop restoration filters; or a constrained directional enhancement filter (CDEF).

Example 21. The method according to any of examples 14 to 20, wherein the performing the one or more adaptations comprises combining multiple ones of the adaptations.

Example 22. The method according to any of examples 1 to 21, wherein the identifying the picture has blocks containing smooth content further identifies blocks containing mixed content, and wherein the method further comprises indicating, by the encoder in or along a bitstream, adaptations applied to blocks containing smooth content or blocks containing mixed content, comprising one or both of the following: deactivation of one or more first in-loop filters; or modifications to one or more second in-loop filters.

Example 23. The method according to any of examples 1 to 21, wherein the encoder performs a smoothness analysis, as part of the identifying whether the picture has blocks containing smooth content, on reconstructed content to identify blocks of smooth content, and the method further compress signaling use of the smoothness analysis approach and parameters used in the smoothness analysis approach.

Example 24. The method according to any of examples 1 to 21, wherein the encoder receives external smoothness information to make a decision using a smoothness analysis for the identifying of the blocks containing smooth content, and the information comes either from guided coding, unguided coding, or information according to a previous example is used to adapt encoder decisions, or from a generated smoothness map created by the encoder as output of the encoder smoothness analysis.

Example 25. The method according to any of examples 1 to 21, further comprising indicating, by the encoder in or along a bitstream, a source of smoothness information, comprising: individual video streams; separate layers for multi-layer coding; separate sublayers; separate pictures in a temporally interleaved manner in a same coded layer video sequence; or separate constituent frames in spatially frame-packed video.

Example 26. The method according to any of examples 1 to 21, further comprising signaling, by the encoder, adaptations performed for each block where the adaptations are taken.

Example 27. The method according to any of examples 1 to 21, further comprising signaling, by the encoder, a prediction mode introduced to represent coding of smooth blocks.

Example 28. The method according to example 1, wherein identifying the picture has blocks containing smooth content is performed by one of the following: determining these blocks have smooth content; or determining other blocks in the picture have mixed content and therefore these blocks have smooth content.

Example 29. A method, comprising: receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

Example 30. The method according to example 29, wherein the decoding according at least to available coding adaptation information and the smooth content information comprises performing an adaption comprising skipping any further block sub-partitioning once a block has been identified as smooth content.

Example 31. The method according to example 29, wherein the decoding according at least to available coding adaptation information and the smooth content information comprises performing an adaption comprising raising quantization parameter offsets for corresponding blocks identified as smooth content.

Example 32. The method according to example 29, wherein the decoding according at least to available coding adaptation information and the smooth content information comprises performing an adaption comprising identifying a picture has blocks containing smooth content and further identifying blocks containing mixed content, and lowering quantization parameter offsets for corresponding blocks identified as containing mixed content.

Example 33. The method according to example 29, wherein the decoding according at least to available coding adaptation information and the smooth content information comprises performing an adaption comprising skipping residual coding for blocks identified as containing smooth content.

Example 34. The method according to example 29, wherein the decoding according at least to available coding adaptation information and the smooth content information comprises performing an adaption comprising deactivating certain in-loop filters for blocks identified as smooth content, comprising deactivating one or more of the following: luma mapping with chroma scaling (LMCS); a sample adaptive offset filter (SAO); an adaptive loop filter (ALF); a cross-component adaptive loop filter (CCALF), a cross-component sample adaptive offset filter (CCSAO), a neural network-based filter; a bilateral filter; a loop restoration filter; or a constrained directional enhancement filter (CDEF).

Example 35. The method according to example 29, wherein the decoding according at least to available coding adaptation information and the smooth content information comprises performing an adaption comprising adapting filter settings for certain in-loop filters for blocks identified as smooth content, and comprising adapting filter settings for one or more of the following: an adaptive loop filter (ALF); a cross-component adaptive loop filter (CCALF); a cross-component sample adaptive offset filter (CCSAO); a neural network-based filter; one or more loop restoration filters; or a constrained directional enhancement filter (CDEF).

Example 36. The method according to any of examples 31 to 35, wherein the performing the one or more adaptations comprises combining multiple ones of the adaptations.

Example 37. The method according to any of examples 29 to 36, further comprising outputting, by the apparatus, the decoded video data for display to a user.

Example 38. A computer program, comprising instructions for performing the methods of any of examples 1 to 37, when the computer program is run on an apparatus.

Example 39. The computer program according to example 38, wherein the computer program is a computer program product comprising a computer-readable medium bearing instructions embodied therein for use with the apparatus.

Example 40. The computer program according to example 38, wherein the computer program is directly loadable into an internal memory of the apparatus.

Example 41. An apparatus, comprising means for performing: receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

Example 42. The apparatus according to example 41, wherein identifying whether the picture has a piece-wise smooth value distribution comprises: identifying whether the picture has a piece-wise smooth value distribution; and identifying, responsive to the picture having a piece-wise smooth value distribution, smooth blocks in the picture.

Example 43. The apparatus according to one of examples 41 or 62, wherein identifying whether the picture has a piece-wise smooth value distribution comprises performing a smoothness test comprising: dividing the picture into blocks; checking individual blocks for a presence of smooth value distribution; and deciding, for the individual blocks, whether this block contains either fully smooth content as the smooth content, or mixed smooth and transitional content as mixed content.

Example 44. The apparatus according to example 43, wherein the decision is made at least by using a smoothness test analyzing a gradient between all adjacent pixel values in a block, and in response to the gradient between one or more pixel values of the block being larger than a threshold, then the block is classified as containing mixed content.

Example 45. The apparatus according to example 43, wherein the decision is made at least by using a smoothness test applying a two-dimensional Sobel operator to the block horizontally, vertically or both horizontally and vertically, and in response to a resulting output image having any pixel value above a threshold, then the block is classified as containing mixed content.

Example 46. The apparatus according to example 43, wherein the decision is made at least by using a smoothness test analyzing a derivate of a gradient between all adjacent pixel values, and in response to derivates being close to zero or a gradual value change, then the block is classified as smooth content.

Example 47. The apparatus according to example 43, wherein the decision is made at least by using a smoothness test analyzing pixels in a frequency domain, wherein smooth content exhibits lower-frequency components, while mixed content exhibits higher-frequency components.

Example 48. The apparatus according to example 43, wherein the decision is made at least by using a smoothness test performing a histogram analysis wherein all pixel values of the block are grouped in bins of a histogram, and in response to the histogram having a smooth value distribution, then the block is classified as smooth content.

Example 49. The apparatus according to example 43, wherein the decision is made at least by using a smoothness test analyzing variance of all pixel values in a block, and in response to the variance of pixel values for the block being above a threshold, then the block is classified as containing mixed content.

Example 50. The apparatus according to any of examples 43 to 49, wherein one or more of the smoothness tests are combined.

Example 51. The apparatus according to any of examples 43 to 49, wherein the encoder receives external guidance information suitable to identify blocks of smooth content within the picture, and the external guidance information comprises: one of ROA masks or inverted ROI masks; occupancy maps; or one of object masks or inverted object masks.

Example 52. The apparatus according to any of examples 41 to 51, wherein the encoding encodes a block that has been identified to contain smooth content only; and the performing the one or more adaptations comprises adapting the encoding decisions for this coded block.

Example 53. The apparatus according to any of examples 41 to 52, wherein the encoding encodes a block that has identified to contain mixed content only; and the performing the one or more adaptations comprises adapting the encoding decisions for this coded block.

Example 54. The apparatus according to any of examples 41 to 53, wherein the performing the one or more adaptations comprises skipping any further block sub-partitioning once a block has been identified as smooth content.

Example 55. The apparatus according to any of examples 41 to 53, wherein the performing the one or more adaptations comprises raising quantization parameter offsets for corresponding blocks identified as smooth content.

Example 56. The apparatus according to any of examples 41 to 53, wherein the identifying the picture has blocks containing smooth content further identifies blocks containing mixed content, wherein the performing the one or more adaptations comprises lowering quantization parameter offsets for corresponding blocks identified as containing mixed content.

Example 57. The apparatus according to any of examples 41 to 53, wherein the performing the one or more adaptations comprises skipping residual coding for blocks identified as containing smooth content.

Example 58. The apparatus according to any of examples 41 to 53, wherein the performing the one or more adaptations comprises deactivating motion estimation for blocks identified as containing smooth content.

Example 59. The apparatus according to any of examples 41 to 53, wherein the performing the one or more adaptations comprises deactivating certain in-loop filters for blocks identified as smooth content, comprising deactivating one or more of the following: luma mapping with chroma scaling (LMCS); a deblocking filter (DBF) that follows an encoding process; a sample adaptive offset filter (SAO); an adaptive loop filter (ALF); a cross-component adaptive loop filter (CCALF), a cross-component sample adaptive offset filter (CCSAO), a neural network-based filter; a bilateral filter; a loop restoration filter; or a constrained directional enhancement filter (CDEF).

Example 60. The apparatus according to any of examples 41 to 53, wherein the performing the one or more adaptations comprises adapting filter settings for certain in-loop filters for blocks identified as smooth content, comprising adapting filter settings for one or more of the following: an adaptive loop filter (ALF); a cross-component adaptive loop filter (CCALF); a cross-component sample adaptive offset filter (CCSAO); a neural network-based filter; one or more loop restoration filters; or a constrained directional enhancement filter (CDEF).

Example 61. The apparatus according to any of examples 54 to 60, wherein the performing the one or more adaptations comprises combining multiple ones of the adaptations.

Example 62. The apparatus according to any of examples 41 to 61, wherein the identifying the picture has blocks containing smooth content further identifies blocks containing mixed content, and wherein the means are further configured for performing: indicating, by the encoder in or along a bitstream, adaptations applied to blocks containing smooth content or blocks containing mixed content, comprising one or both of the following: deactivation of one or more first in-loop filters; or modifications to one or more second in-loop filters.

Example 63. The apparatus according to any of examples 41 to 61, wherein the encoder performs a smoothness analysis, as part of the identifying whether the picture has blocks containing smooth content, on reconstructed content to identify blocks of smooth content, and wherein the means are further configured for performing: signaling use of the smoothness analysis approach and parameters used in the smoothness analysis approach.

Example 64. The apparatus according to any of examples 41 to 61, wherein the encoder receives external smoothness information to make a decision using a smoothness analysis for the identifying of the blocks containing smooth content, and the information comes either from guided coding, unguided coding, or information according to a previous example is used to adapt encoder decisions, or from a generated smoothness map created by the encoder as output of the encoder smoothness analysis.

Example 65. The apparatus according to any of examples 41 to 61, wherein the means are further configured for performing: indicating, by the encoder in or along a bitstream, a source of smoothness information, comprising: individual video streams; separate layers for multi-layer coding; separate sublayers; separate pictures in a temporally interleaved manner in a same coded layer video sequence; or separate constituent frames in spatially frame-packed video.

Example 66. The apparatus according to any of examples 41 to 61, wherein the means are further configured for performing: signaling, by the encoder, adaptations performed for each block where the adaptations are taken.

Example 67. The apparatus according to any of examples 41 to 61, further comprising signaling, by the encoder, a prediction mode introduced to represent coding of smooth blocks.

Example 68. The apparatus according to example 41, wherein identifying the picture has blocks containing smooth content is performed by one of the following: determining these blocks have smooth content; or determining other blocks in the picture have mixed content and therefore these blocks have smooth content.

Example 69. An apparatus, comprising means for performing: receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

Example 70. The apparatus according to example 69, wherein the decoding according at least to available coding adaptation information and the smooth content information comprises performing an adaption comprising skipping any further block sub-partitioning once a block has been identified as smooth content.

Example 71. The apparatus according to example 69, wherein the decoding according at least to available coding adaptation information and the smooth content information comprises performing an adaption comprising raising quantization parameter offsets for corresponding blocks identified as smooth content.

Example 72. The apparatus according to example 69, wherein the decoding according at least to available coding adaptation information and the smooth content information comprises performing an adaption comprising identifying a picture has blocks containing smooth content and further identifying blocks containing mixed content, and lowering quantization parameter offsets for corresponding blocks identified as containing mixed content.

Example 73. The apparatus according to example 69, wherein the decoding according at least to available coding adaptation information and the smooth content information comprises performing an adaption comprising skipping residual coding for blocks identified as containing smooth content.

Example 74. The apparatus according to example 69, wherein the decoding according at least to available coding adaptation information and the smooth content information comprises performing an adaption comprising deactivating certain in-loop filters for blocks identified as smooth content, comprising deactivating one or more of the following: luma mapping with chroma scaling (LMCS); a sample adaptive offset filter (SAO); an adaptive loop filter (ALF); a cross-component adaptive loop filter (CCALF), a cross-component sample adaptive offset filter (CCSAO), a neural network-based filter; a bilateral filter; a loop restoration filter; or a constrained directional enhancement filter (CDEF).

Example 75. The apparatus according to example 69, wherein the decoding according at least to available coding adaptation information and the smooth content information comprises performing an adaption comprising adapting filter settings for certain in-loop filters for blocks identified as smooth content, and comprising adapting filter settings for one or more of the following: an adaptive loop filter (ALF); a cross-component adaptive loop filter (CCALF); a cross-component sample adaptive offset filter (CCSAO); a neural network-based filter; one or more loop restoration filters; or a constrained directional enhancement filter (CDEF).

Example 76. The apparatus according to any of examples 71 to 75, wherein the performing the one or more adaptations comprises combining multiple ones of the adaptations.

Example 77. The apparatus according to any of examples 69 to 76, wherein the means are further configured for performing: outputting, by the apparatus, the decoded video data for display to a user.

Example 78. The apparatus of any preceding apparatus example, wherein the means comprises: at least one processor; and at least one memory storing instructions that, when executed by at least one processor, cause the performance of the apparatus.

Example 79. An apparatus, comprising: one or more processors; and one or more memories storing instructions that, when executed by the one or more processors, cause the apparatus at least to perform: receiving, by an encoder implemented by an apparatus as part of an encoding process of input video, a picture; identifying, by the encoder, the picture has blocks containing smooth content; encoding, by the encoder, a bitstream comprising at least one coded picture, and performing, by the encoder, one or more adaptations to encoding decisions made in the encoding based on the identified blocks containing the smooth content.

Example 80. The apparatus of example 79, wherein the one or more memories further store instructions that, when executed by the one or more processors, cause the apparatus at least to perform the methods of any of claims 2 to 28.

Example 81. An apparatus, comprising: one or more processors; and one or more memories storing instructions that, when executed by the one or more processors, cause the apparatus at least to perform: receiving, by a decoder implemented by an apparatus as part of a decoding process, a bitstream comprising video data and containing smooth content information from which a determination of which blocks contain smooth content can be made; and decoding, by the decoder, the video data, according at least to available coding adaptation information and the smooth content information.

Example 82. The apparatus of example 81, wherein the one or more memories further store instructions that, when executed by the one or more processors, cause the apparatus at least to perform the methods of any of claims 30 to 37.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 13. A computer-readable medium may comprise a computer-readable storage medium (e.g., memories 1325 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two-dimensional
3D three-dimensional
ALF adaptive loop filter
AMVP advanced motion vector prediction
CCALF cross-component adaptive loop filter
CCSAO cross-component sample adaptive offset filter
CDEF constrained directional enhancement filter
CTU coding tree unit
CU coding unit
DBF deblocking filter
DCT discrete cosine transform
DST discrete sine transform
H.264/AVC Advanced video coding, where H.264 is a video coding/compression standard
HEVC High Efficiency Video Coding
ID identification
LMCS luma mapping with chroma scaling
MCP motion-compensated prediction
MIV MPEG immersive video
MPEG Motion picture experts group
NN neural network
PU prediction unit
QP quantization parameter
ROI region of interest
SAO sample adaptive offset (filter)
SEI supplemental enhancement information
TU transform unit
V3C volumetric video-based coding
VCM Video Coding for Machine
V-DMC V3C dynamic mesh coding
V-PCC Video-based point cloud compression
VVC versatile video coding

What is claimed is:

1. An apparatus comprising: at least one processor; and at least one memory including computer program code; wherein the at least one memory and the computer program code are configured to, with the at least one processor, cause the apparatus at least to:
receive, by an encoder implemented by an apparatus as part of an encoding process of input video, a picture;
identify, by the encoder, the picture has blocks containing smooth content;
encode, by the encoder, a bitstream comprising at least one coded picture, and
perform, by the encoder, one or more adaptations to encoding decisions made in the encoding based on the identified blocks containing the smooth content.

2. The apparatus according to claim 1, wherein to identify whether the picture has blocks containing smooth content, the apparatus is further caused to:
identify whether the picture has a piece-wise smooth value distribution; and
identify, responsive to the picture having a piece-wise smooth value distribution, smooth blocks in the picture.

3. The apparatus according to claim 1, wherein to identify whether the picture has blocks containing smooth content, the apparatus is further caused to:
perform a smoothness test comprising: dividing the picture into blocks; checking individual blocks for a presence of smooth value distribution; and
deciding, for the individual blocks, whether this block contains either fully smooth content as the smooth content, or mixed smooth and transitional content as mixed content.

4. The apparatus according to claim 3, wherein the decision is made at least by using a smoothness test analyzing a gradient between all adjacent pixel values in a block, and in response to the gradient between one or more pixel values of the block being larger than a threshold, then the block is classified as containing mixed content.

5. The apparatus according to claim 3, wherein the decision is made at least by using a smoothness test applying a two-dimensional Sobel operator to the block horizontally, vertically or both horizontally and vertically, and in response to a resulting output image having any pixel value above a threshold, then the block is classified as containing mixed content.

6. The apparatus according to claim 1, wherein to perform the one or more adaptations, the apparatus is further caused to:
deactivate one or more of the following for blocks identified as smooth content:
luma mapping with chroma scaling (LMCS);
a deblocking filter (DBF) that follows an encoding process;
a sample adaptive offset filter (SAO);
an adaptive loop filter (ALF);
a cross-component adaptive loop filter (CCALF),
a cross-component sample adaptive offset filter (CCSAO),
a neural network-based filter;
a bilateral filter;
a loop restoration filter; or
a constrained directional enhancement filter (CDEF).

7. The apparatus according to claim 1, wherein to perform the one or more adaptations, the apparatus is further caused to:
adapt filter settings for one or more of the following for blocks identified as smooth content, comprising adapting filter settings:
an adaptive loop filter (ALF);
a cross-component adaptive loop filter (CCALF);
a cross-component sample adaptive offset filter (CCSAO);
a neural network-based filter;
one or more loop restoration filters; or
a constrained directional enhancement filter (CDEF).

8. The apparatus according to claim 1, wherein the encoder receives external guidance information suitable to identify blocks of smooth content within the picture, and the external guidance information comprises:
one of ROA masks or inverted ROI masks;
occupancy maps; or
one of object masks or inverted object masks.

9. An apparatus comprising: at least one processor; and at least one memory including computer program code; wherein the at least one memory and the computer program code are configured to, with the at least one processor, cause the apparatus at least to:
receive, by a decoder implemented by an apparatus as part of a decoding process, a bitstream comprising video data and containing smooth content information from which a determination of which blocks contain smooth content can be made; and
decode, by the decoder, the video data, according at least to available coding adaptation information and the smooth content information.

10. The apparatus according to claim 9, wherein to decode according at least to available coding adaptation information and the smooth content information, the apparatus is further caused to: perform an adaption comprising: skipping any further block sub-partitioning once a block has been identified as smooth content.

11. The apparatus according to claim 9, wherein to decode according at least to available coding adaptation information and the smooth content information, the apparatus is further caused to: perform an adaption comprising: raising quantization parameter offsets for corresponding blocks identified as smooth content.

12. The apparatus according to claim 9, wherein to decode according at least to available coding adaptation information and the smooth content information, the apparatus is further caused to: perform an adaption comprising: identifying a picture has blocks containing smooth content and further identifying blocks containing mixed content, and lowering quantization parameter offsets for corresponding blocks identified as containing mixed content.

13. The apparatus according to claim 9, wherein to decode according at least to available coding adaptation information and the smooth content information, the apparatus is further caused to: perform an adaption: comprising skipping residual coding for blocks identified as containing smooth content.

14. The apparatus according to claim 9, wherein to decode according at least to available coding adaptation information and the smooth content information, the apparatus is further caused to: deactivate one or more of the following for blocks identified as smooth content:
luma mapping with chroma scaling (LMCS);
a sample adaptive offset filter (SAO);
an adaptive loop filter (ALF);
a cross-component adaptive loop filter (CCALF),
a cross-component sample adaptive offset filter (CCSAO),
a neural network-based filter;
a bilateral filter;
a loop restoration filter; or
a constrained directional enhancement filter (CDEF).

15. The apparatus according to claim 9, wherein to decode according at least to available coding adaptation information and the smooth content information, the apparatus is further caused to: adapt filter settings for one or more of the following for blocks identified as smooth content:
an adaptive loop filter (ALF);
a cross-component adaptive loop filter (CCALF);
a cross-component sample adaptive offset filter (CCSAO);
a neural network-based filter;
one or more loop restoration filters; or
a constrained directional enhancement filter (CDEF).

16. A method, comprising:
receiving, by a decoder implemented by an apparatus as part of a decoding process, a bitstream comprising video data and containing smooth content information from which a determination of which blocks contain smooth content can be made; and
decoding, by the decoder, the video data, according at least to available coding adaptation information and the smooth content information.

17. The method according to claim 16, wherein the decoding according at least to available coding adaptation information and the smooth content information comprises performing an adaption comprising skipping any further block sub-partitioning once a block has been identified as smooth content.

18. The method according to claim 16, wherein the decoding according at least to available coding adaptation information and the smooth content information comprises performing an adaption comprising raising quantization parameter offsets for corresponding blocks identified as smooth content.

19. The method according to claim 16, wherein the decoding according at least to available coding adaptation information and the smooth content information comprises performing an adaption comprising identifying a picture has blocks containing smooth content and further identifying blocks containing mixed content, and lowering quantization parameter offsets for corresponding blocks identified as containing mixed content.

20. The method according to claim 16, wherein the decoding according at least to available coding adaptation information and the smooth content information comprises performing an adaption comprising skipping residual coding for blocks identified as containing smooth content.
